(19) United States
(12) Patent Application Publication
(10) Pub. No.: US 2025/0276368 A1
(43) Pub. Date: Sep. 4, 2025

(54) ADDITIVE MANUFACTURING TECHNIQUES FOR ABRASIVE COATINGS USING IN SITU REACTION

(71) Applicant: Rolls-Royce Corporation, Indianapolis, IN (US)

(72) Inventor: Scott Nelson, Indianapolis, IN (US)

(21) Appl. No.: 18/593,569

(22) Filed: Mar. 1, 2024

(51) Int. Cl. B22F 10/34; B22F 7/04; B22F 10/368; B24D 18/00; B33Y 50/02; B33Y 70/10; B33Y 80/00

(52) U.S. Cl. CPC B22F 10/34; B22F 7/04; B22F 10/368; B24D 18/0054; B33Y 70/10; B33Y 50/02; B33Y 80/00

(57) ABSTRACT

A method for additive manufacturing includes controlling, by a computing device, a powder delivery device to deliver a metal powder to a build surface of an abrasive coating and controlling, by the computing device, an energy delivery device to deliver energy to a melt pool of the build surface to form a metal matrix composite via an in situ reaction. The metal matrix composite includes a ceramic phase in a metal matrix.

### TECHNICAL FIELD

The disclosure relates to additive manufacturing techniques, such as for forming abrasive coatings for high temperature mechanical systems.

### BACKGROUND

Additive manufacturing processes generate components through addition of material layer-by-layer or volume-by-volume to form the component, rather than removing material from an existing substrate to generate the component. Additive manufacturing may be advantageous in many situations, such as rapid prototyping, forming components with complex three-dimensional structures, or the like. In some examples, additive manufacturing may utilize powdered materials, and may melt or sinter at least a portion of the powdered material together to form coatings on substrates. For example, superalloy, ceramic, or CMC substrates may be coated with an abradable coating to improve a seal between the substrate and an adjacent component. The integrity of these coatings may be dependent on a microstructure of the coatings.

### SUMMARY

The disclosure describes additive manufacturing systems, including methods for operating additive manufacturing systems and articles fabricated from additive manufacturing systems, that manufacture an article by forming an abrasive coating on a substrate using an in situ reaction during additive manufacturing. An additive manufacturing system includes an energy delivery device that delivers energy to a build surface of the abrasive coating to form a melt pool and a powder delivery device that directs a powder stream toward the melt pool. The powder includes a reactive metal powder, and at least a portion of the powder reacts upon deposition to form a ceramic phase in a metal matrix. The ceramic phase reinforces the metal matrix, and may form larger ceramic phases that replace ceramic abrasives that may otherwise be mixed with the reactive metal powder. In this way, systems described herein may produce articles having coatings with a low proportion of defects.

In some examples, the disclosure describes a method for additive manufacturing that includes controlling, by a computing device, a powder delivery device to deliver a metal powder to a build surface of an abrasive coating and controlling, by the computing device, an energy delivery device to deliver energy to a melt pool of the build surface to form a metal matrix composite via an in situ reaction. The metal matrix composite includes a ceramic phase in a metal matrix.

In some examples, the disclosure describes an additive manufacturing system that includes an energy delivery device, a powder delivery device, and a computing device. The energy delivery device is configured to deliver energy to a build surface of a component to form a melt pool in the build surface. The powder delivery device is configured to direct a powder stream toward the melt pool. The computing device is configured to control the powder delivery device to deliver metal powder to the build surface and control the energy delivery device to deliver energy to the melt pool to form a metal matrix composite via an in situ reaction. The metal matrix composite includes a ceramic phase in a metal matrix.

In some examples, the disclosure describes an article that includes a substrate and an abrasive coating overlying the substrate. The abrasive coating includes a metal matrix composite, and the metal matrix composite includes a ceramic phase in a metal matrix.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a side view cross-sectional schematic diagram illustrating an example article that includes an abrasive coating formed from an additive manufacturing process.

FIG. 1B is an expanded side view cross-sectional schematic diagram illustrating an example abrasive coating of the article of FIG. 1A.

FIG. 1C is an expanded side view cross-sectional schematic diagram illustrating an example abrasive coating of the article of FIG. 1A.

FIG. 2 is a conceptual block diagram illustrating an example additive manufacturing system.

FIG. 3 is a flowchart illustrating an example method for fabricating a component.

### DETAILED DESCRIPTION

The disclosure generally describes techniques and systems for fabricating a coating on a substrate using a blown powder additive manufacturing technique, such as a directed energy deposition (DED) technique, via an in situ reaction. During blown powder additive manufacturing, a coating is built up by adding material to the substrate and/or coating in sequential layers. The final article is composed of a coating having a plurality of layers of material. In some blown powder additive manufacturing techniques for forming components from metals or alloys, an energy source may direct energy at a substrate to form a melt pool. A powder delivery device may deliver a powder to the melt pool, where at least some of the powder at least partially melts and is joined to the melt pool and, thus, substrate.

An abrasive coating may include abrasive particles in a matrix. The abrasive particles in the abrasive coating may allow a component, such as a blade tip, to abrade or otherwise cut into an abradable coating on another components, such as a blade shroud, during a first use of the component. It may be desirable for the abrasive particles to remain attached to the component throughout the life of the component so that the particles can later compensate for changes in the component, such as may be caused by creep during the life of the component.

During deposition, the matrix powder forming the matrix may melt and bind the abrasive particles within the abrasive coating. However, the solid abrasive particles may not be sufficiently captured into the matrix, or may dissolve into the matrix. While the matrix solidifies, cracks may form at an interface between the matrix and the abrasive particles. As a result, the abrasive coating may be susceptible to damage, such as cracking or delamination, when the article is put into operation.

In accordance with techniques of this disclosure, an additive manufacturing system may form a reinforcing ceramic phase in the abrasive coating via an in situ reaction. The additive manufacturing system delivers a reactive metal powder to the melt, alone or in combination with ceramic abrasive particles. The reactive metal powder reacts through an additive reaction to form the reinforcing ceramic phase that increases a strength of the matrix and limits solidification cracking as the matrix cools. In examples in which the reactive metal powder is delivered with ceramic abrasive particles, the reinforcing ceramic phase may further react with the ceramic abrasive particles to form a protective layer that resists dissolution and/or may promote wetting of the molten matrix to the ceramic abrasive particles to increase particle capture. In some examples, the reinforcing ceramic phase may form macro-scale precipitates of ceramic phases that supplement or replace the ceramic abrasive particles, thereby reducing an effect of particle capture on particle loading. In these various ways, the reinforcing ceramic phase may reduce damage to and prolong the effective life of the abrasive coatings.

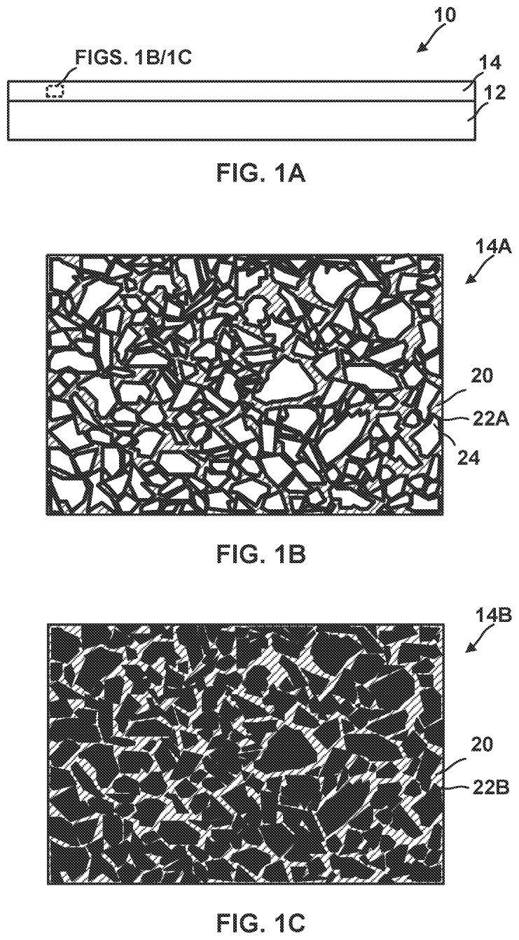

FIG. 1A is a side view cross-sectional schematic diagram illustrating an example article 10 that includes an abrasive coating 14 formed from an additive manufacturing process. Article 10 may include a component of a gas turbine engine. For example, article 10 may include a part that forms a portion of a flow path structure or another portion of the gas turbine engine, such as a compressor blade or a turbine blade, that may be in close proximity to another component for sealing purposes.

Article 10 includes a substrate 12. Substrate 12 may be formed of a material suitable for use in a high-temperature environment. In some examples, substrate 12 includes titanium alloys, intermetallics and superalloys, such as an alloy based on nickel (Ni), cobalt (Co), Ni/iron (Fe), or the like. In examples in which substrate 12 includes a superalloy material, substrate 12 may also include one or more additives such as titanium (Ti), Co, or aluminum (Al), which may improve the mechanical properties of substrate 12 including, for example, toughness, hardness, temperature stability, corrosion resistance, oxidation resistance, or the like.

In other examples, substrate 12 may include a ceramic or ceramic matrix composite (CMC) substrate, although a change in bond-type chemistry and/or surface preparation from that used for superalloy substrates may be necessary for ceramic or CMC substrates. Substrate 12 may include any useful ceramic material, including, for example, silicon carbide, silicon nitride, alumina, silica, and the like. A CMC may further include any desired filler material, and the filler material may include a continuous reinforcement or a discontinuous reinforcement. The filler composition, shape, size, and the like may be selected to provide the desired properties to the CMC. For example, the filler material may be chosen to increase the toughness of a brittle ceramic matrix or modify a thermal conductivity, electrical conductivity, thermal expansion coefficient, hardness, or the like of the CMC. Some example ceramics and CMCs which may be used for substrate 12 include ceramics containing Si, such as SiC and Si₃N₄; composites of SiC or Si₃N₄ and silicon oxynitride or silicon aluminum oxynitride; and metal alloys that include Si, such as a molybdenum-silicon alloy (e.g., MoSi₂) or niobium-silicon alloys (e.g., NbSi₂).

Article 10 includes an abrasive coating 14 overlying substrate 12. Abrasive coating 14 includes a metal matrix composite configured to abrade an abradable coating. For example, article 10 may be configured to pair with an adjacent component having an abradable coating. Abrasive coating 14 may be withstand a high temperature oxidative environment. For example, abradable coating 14 may be configured to withstand temperatures up to about 1200° C., such that abradable coating 14 may remain on substrate 12 over an extended period of time to account for dimensional changes that may occur in article 10, and corresponding clearance with respect to an adjacent component having the abradable coating.

The metal matrix composite includes ceramic abrasive powder or precipitates dispersed in a metal matrix, such that the metal matrix functions as a binder for the ceramic abrasive powder or precipitates. The ceramic abrasive powder or precipitates are configured to abrade the abradable coating. The metal matrix composite includes one or more ceramic phases dispersed in the metal matrix. As will be described further below, the one or more ceramic phases may reinforce the metal matrix composite on a micro-scale and, in some instances, replace or supplement the ceramic abrasive particles on a macro-scale. As used herein, ceramic abrasive powder may refer to ceramic abrasive particles present in the metal matrix composite that are formed prior to deposition, while ceramic abrasive precipitates may refer to ceramic abrasive particles present in the metal matrix composite as a result of an in situ reaction during or after deposition.

The metal matrix forms from an in situ reaction that involves a reactive metal powder. As such, metal matrix may include any suitable metal formed from the reactive metal powder. Metals may include, but are not limited to, nickel, titanium, magnesium, cobalt, aluminum, chromium, and alloys thereof. In some examples, the metal matrix includes at least one of titanium, a titanium alloy, nickel, a nickel alloy, cobalt, a cobalt alloy, or a ferrous alloy.

In addition to the metal matrix, the one or more ceramic phases also form from the in situ reaction involving the reactive metal powder. As such, the one or more ceramic phases may include any suitable ceramic formed from the reactive metal powder, and optionally another reactant, such as a reactive gas. In some examples, the one or more ceramic phases includes carbon, a nitride, alumina, zirconia, or hafnia.

As deposited, abrasive coating 14 may have any suitable thickness, which may be substantially uniform or non-uniform on substrate 12. In some examples, the thickness may be greater than about 44 micrometers, less than 2 millimeters, or about 100 to about 500 micrometers. While FIG. 1A illustrates abrasive coating 14 being formed of a single layer, abrasive coating 14 may be formed of multiple layers, e.g., multiple layers deposited sequentially on top of each other until a desired overall thickness of abrasive coating 14 is achieved.

In some examples, the one or more ceramic phases may form a reinforcing phase in addition to the ceramic abrasive powder. FIG. 1B is an expanded side view cross-sectional schematic diagram illustrating an example abrasive coating 14A of article 10 of FIG. 1A. In the example of FIG. 1B, abrasive coating 14A is formed from a metal matrix composite that includes a ceramic abrasive powder 24 in a metal matrix 20. As will be described further below, abrasive coating 14 may include a plurality of abrasive particles in a metal matrix. For example, abrasive coating 14 may include a plurality of abrasive particles such as cubic boron nitride and/or other suitable particles in a metal alloy such as a titanium alloy, nickel alloy, ferrous alloy, or other suitable metal alloy.

Any suitable material may be used for ceramic abrasive powder 24 including, but not limited to, one or more of cubic boron nitride particles, carbide particles, metal carbide particles, metal oxide particles, nitride particles, metal nitride particles, such as silicon carbide, aluminum oxide, or silicon nitride. In some examples, ceramic abrasive powder 24 may have a volume-weighted average size of greater than about 100 micrometers and less than about 2 millimeters. In some examples, the volume-weighted average size of ceramic abrasive powder 24 may depend on a number of factors, such as a thickness of abrasive coating 14A after being deposited. Ceramic abrasive powder 24 may have any suitable shape.

In addition to ceramic abrasive powder 24 and metal matrix 20, the metal matrix composite of abrasive coating 14A includes a ceramic phase 22A. In the example of FIG. 1B, ceramic phase 22A is formed at or migrates to an interface between ceramic abrasive powder 24 and metal matrix 20. However, ceramic phase 22A may form at other locations within metal matrix 20, such as at grain boundaries of metal matrix 20 or as discrete precipitates in metal matrix 20. Without being limited to any particular theory, a reactive metal powder may react with another reactant, such as another reactive powder or gas, to form metal matrix 20 and ceramic phase 22A. Ceramic phase 22A may function as a reinforcing phase to metal matrix 20, and optionally, a wetting agent for ceramic abrasive powder 24. For example, ceramic phase 22A may reinforce grains of metal matrix 20 and limit cracking of metal matrix 20 that may result from solidification of metal matrix 20. Additionally, ceramic phase 22A may increase wetting between molten metal of metal matrix 20 and ceramic abrasive powder 24 during deposition, thereby increasing loading of ceramic abrasive powder 24 in abrasive coating 14A.

Any suitable reaction product resulting from the in situ reaction may be used for ceramic phase 22A including, but not limited to, titanium carbide, titanium boride, silicon carbide, tungsten carbide, boron carbide, nickel titanium, molybdenum silicide, alumina, molybdenum selenide, calcium phosphate (Ca₃(PO₄)₂, or the like. In some examples, a composition of ceramic abrasive powder 24 is different from a composition of ceramic phase 22A. For example, ceramic abrasive powder 24 may be selected for mechanical properties related to abrasion, while ceramic phase 22A may be selected for chemical properties related to reaction between the reactive metal powder and the other reactant and mechanical properties related to reinforcing metal matrix 20.

In some examples, ceramic phase 22A may be a reaction product between the reactive metal powder forming metal matrix 20 and ceramic abrasive powder 24. For example, ceramic abrasive powder 24 may be susceptible to dissolution into metal matrix 20. By forming ceramic phase 22A on ceramic abrasive powder 24, ceramic phase 22A may act as a passivation layer that seals ceramic abrasive powder 24 and reduces dissolution of ceramic abrasive powder 24 into metal matrix 20. In such examples, an average thickness of ceramic phase 22A may be less than about 1 millimeter, such as less than about 100 microns.

Abrasive coating 14A may have any suitable relative composition, e.g., that allows abrasive coating 14A to function as described herein. In some examples, abrasive coating 14A may include at least about 10 volume percent (vol %) of ceramic abrasive powder 24, such as about 50 to about 80 vol %, or less than about 95 vol % of ceramic abrasive powder 24. Abrasive coating 14A may also include at least about 5 vol % of metal matrix 20, such as about 20 to about 50 vol %, or less than about 90 vol % of metal matrix 20. Abrasive coating 14A may include at least about 1 vol % of ceramic phase 22A, such as about 20 vol % to about 65 vol % of ceramic phase 22A.

In some examples, the one or more ceramic phases may form ceramic abrasive precipitates configured to function as an abrasive material in abrasive coating 14. FIG. 1C is an expanded side view cross-sectional schematic diagram illustrating an example abrasive coating 14B of article 10 of FIG. 1A. In the example of FIG. 1C, ceramic phase 22B forms ceramic abrasive precipitates in metal matrix 20. While illustrated as only including phase 22B as ceramic abrasive precipitates, in other examples, abrasive coating 14B may also include ceramic abrasive powder, such as ceramic abrasive powder 24 described in abrasive coating 14A of FIG. 1B. Without being limited to any particular theory, a reactive metal powder may react with another reactant, such as another reactive powder or gas, to form metal matrix 20 and ceramic phase 22B dispersed throughout metal matrix 20. Ceramic phase 22B may function as a reinforcing phase to metal matrix 20 and an abrasive agent for abrasive coating 14B. For example, in addition to the reinforcing function described for ceramic phase 22A in FIG. 1B, precipitates of ceramic phase 22B may be substantially large that the precipitates may be capable of abrading a surface, such as an abradable coating.

Any suitable reaction product resulting from the in situ reaction may be used for ceramic phase 22A including, but not limited to, titanium carbide, titanium boride, silicon carbide, tungsten carbide, boron carbide, nickel titanium, molybdenum silicide, alumina, molybdenum selenide, calcium phosphate (Ca₃(PO₄)₂, or the like. In some examples, precipitates of abrasive phase 22B may have a volume-weighted average size of greater than about 100 micrometers and less than about 2 millimeters. In some examples, the volume-weighted average size of precipitates of abrasive phase 22B may depend on a number of factors, such as a thickness of abrasive coating 14A after being deposited and an availability of reactants. Precipitates of ceramic phase 22B may have any suitable shape.

Abrasive coating 14B may have any suitable relative composition, e.g., that allows abrasive coating 14B to function as described herein. In some examples, abrasive coating 14A may include at least about 2 volume percent (vol %) of ceramic phase 22B, such as about 20 to about 80 vol %, or less than about 95 vol % of ceramic phase 22B. Abrasive coating 14A may also include at least about 5 vol % of metal matrix 20, such as about 20 to about 50 vol %, or less than about 90 vol % of metal matrix 20.

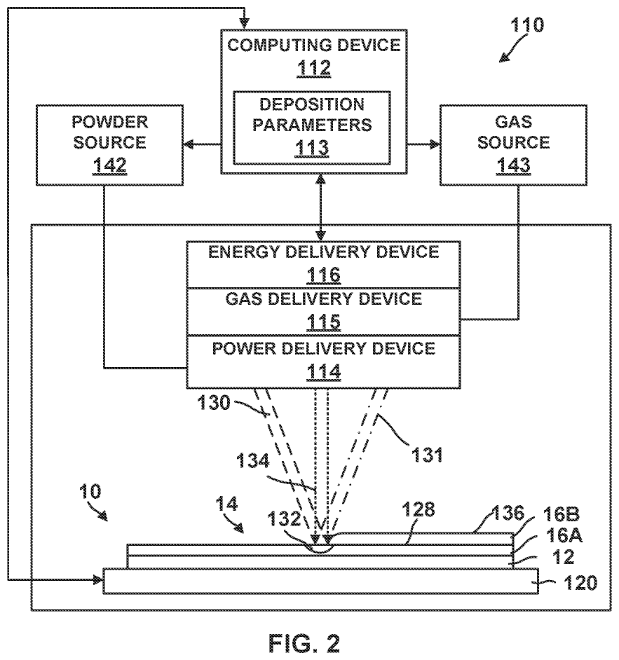

Abrasive coatings described herein may be formed using a reactive additive manufacturing process. FIG. 2 is a conceptual block diagram illustrating an example additive manufacturing system 110. In the example illustrated in FIG. 2, additive manufacturing system 110 includes a computing device 112, a powder delivery device 114, a gas delivery device 115, an energy delivery device 116, a stage 120, a powder source 142, and a gas source 143. Computing device 112 is operably connected to powder delivery device 114, gas delivery device 115, energy delivery device 116, stage 120, powder source 142, and gas source 143. In some examples, stage 120 may be movable relative to powder delivery device 114, gas delivery device 115, and/or energy delivery device 116. Stage 120 may be configured to selectively position and restrain article 10 in place relative to stage 120 during manufacturing of article 10.

Powder source 142 is the source of powder for powder stream 130. Powder source 142 may include any suitable container or enclosure, such as a hopper, configured to hold powder. Powder source 142 also may include mechanism for entraining the powder in a gas flow. For instance, powder source 142 may be coupled to a gas source, which provides a gas flowing through powder source 142 and entraining powder within the gas flow. Additionally, or alternatively, powder source 142 may include an agitator configured to agitate the powder and increase entrainment of the powder in the gas stream.

Powder delivery device 114 may be configured to deliver powder to selected locations of abrasive coating 14 being formed via a powder stream 130. Powder delivery device 114 may include one or more nozzles that each output powder. The combined powder defines powder stream 130. In some examples, powder delivery device 114 includes a single nozzle, which may be point nozzle, or a single nozzle that is an annular channel. In other examples, powder delivery device 114 includes a plurality of nozzles (e.g., three nozzles or four nozzles). Regardless of the number of nozzles, powder delivery device 114 may output powder stream 130 that is focused on a focus plane. As powder delivery device 114 is movable in the z-axis shown in FIG. 2 relative to article 10, the focal plane of powder delivery device 114 also may be movable in the z-axis relative to article 10, such that the focus plane may be controlled to be substantially coincident with build surface 128. At least some of the powder in powder stream 130 may impact a melt pool 132 in article 10. At least some of the powder that impacts melt pool 132 may be joined to article 10.

The powder delivered by powder delivery device 114 may include a reactive metal powder and optionally one or more additional powders. The reactive metal powder may be selected to form metal matrix 20 of the metal matrix composite. In some examples, the reactive metal powder may be selected to be the same as the material of substrate 12 on which abrasive coating 14 is formed. For example, the reactive metal powder may include titanium, a titanium alloy, nickel, a nickel alloy, cobalt, a cobalt alloy, or a ferrous alloy.

In some examples, the powder delivered by powder delivery device 114 may include a second powder. The second powder may form one or more ceramic phases, such as ceramic phases 22A or 22B, of the metal matrix composite. For instance, the second powder may include carbon, a nitride (e.g., titanium nitride, silicon nitride, or the like), a carbide (e.g., titanium carbide, silicon carbide, tungsten carbide, boron carbide, or the like), alumina, silica, hafnia, zirconia, or the like. In other examples, the second powder may react with a component of the reactive metal powder to form the one or more ceramic phases. For example, the second powder may include titanium, carbon, boron, boron carbide (B₄C), silicon, tungsten, nickel, molybdenum, aluminum, titanium oxide, boron oxide, selenium, iron II oxide (Fe₂O₃), calcium oxide, phosphate oxide (P₂O₅), titanium carbide, or the like. The second powder may react with a component of the reactive metal powder via an additive reaction to form a ceramic phase including, for example, titanium carbide, titanium boride, silicon carbide, tungsten carbide, boron carbide, nickel titanium, molybdenum silicide, alumina, molybdenum selenide, calcium phosphate (Ca₃(PO₄)₂, or the like.

An amount of reactive metal powder, and optionally other reactive powders, may be selected based on a desired final amount of the ceramic phases and stoichiometry of the additive reaction that forms the ceramic phases. The first and second materials, when present, may be delivered as part of mixed powder, as two separate powders (e.g., from two different powder delivery devices), or the like. In other examples, the powder delivered by powder delivery device 114 may include a metal powder that forms the metal matrix, and second and third powders that react in the melt pool to form the one or more ceramic phases. The second and third materials may be selected from any of the reactive materials described above, e.g., titanium, carbon, boron, boron carbide (B₄C), silicon, tungsten, nickel, molybdenum, aluminum, titanium oxide, boron oxide, selenium, iron II oxide (Fe₂O₃), calcium oxide, phosphate oxide (P₂O₅), titanium carbide, or the like.

System 110 also includes gas source 143. In some examples, gas source 143 may include, for example, a source of helium, argon, or other substantially inert gas. In some examples, the gas may function as a cooling gas, which cools a portion of article 10 by flowing past the portion of article 10. As used herein, a substantially inert gas may include a gas that does not react with article 10 or the material being added to article 10 during the additive manufacturing process.

In other examples, gas source 143 may include, for example, a source of a reactive gas, e.g., a source of a gas configured to react with the material delivered to the melt pool at 1 focal spot to form a ceramic phase 22 within the metal matrix composite. Reactive gases include, for example, nitrogen, oxygen, carbon, and combinations thereof. In some examples, gas source 143 may provide a mixture of two or more gases, e.g., a mixture of one or more substantially inert gases and one or more reactive gases.

Gas source 143 is fluidically coupled to gas delivery device 115. Although FIG. 2 illustrates system 110 including a single gas delivery device 115, in other examples, system 110 may include more than one gas delivery device 115. Gas source 143 may be fluidically coupled to gas delivery device 115 using a tube, pipe, conduit, or the like, that allows fluid communication between gas source 143 and gas delivery device 115.

Energy delivery device 116 may include an energy source, such as a laser source, an electron beam source, plasma source, or another source of energy that may be absorbed by article 10 to form a melt pool 132 and/or be absorbed by powder in powder stream 130 to be added to article 10. Example laser sources include a CO laser, a CO₂ laser, a Nd:YAG laser, or the like. In some examples, the energy source may be selected to provide energy with a predetermined wavelength or wavelength spectrum that may be absorbed by article 10 and/or the powder to be added to article 10 during the additive manufacturing technique. In some examples, energy delivery device 116 also includes an energy delivery head, which is operatively connected to the energy source. The energy delivery head may aim, focus, or direct energy 134 toward predetermined positions at or adjacent to a surface of article 10 during the additive manufacturing technique. As described above, in some examples, the energy delivery head may be movable in at least one dimension (e.g., translatable and/or rotatable) under control of computing device 112 to direct the energy toward a selected location at or adjacent to a surface of article 10.

In some examples, at least a portion of energy delivery device 116, gas delivery device 115, and powder delivery device 114 may be combined or attached to each other. For example, a deposition head may include part of powder delivery device 114 (e.g., internal channels and powder nozzle(s) for forming powder stream 130 and directing powder stream 130 toward build surface 128) and part of energy delivery device 116 (e.g., the energy delivery head). As shown in FIG. 2, in some examples, energy delivery device 116 may be arranged or configured such that energy 134 and powder stream 130 both exit from a common deposition head and are directed toward build surface 128. For instance, energy 134 may pass through a central channel within the deposition head and exit a central aperture in the deposition head, while fluidized powder may flow through internal channels and powder nozzle(s) for forming powder stream 130 and directing powder stream 130 toward build surface 128.

Computing device 112 is configured to control components of system 110 and may include, for example, a desktop computer, a laptop computer, a workstation, a server, a mainframe, a cloud computing system, or the like. Computing device 112 is configured to control operation of system 110, including, for example, powder delivery device 114, gas delivery device 115, energy delivery device 116, stage 120, powder source 142, and/or gas source 143. Computing device 112 may be communicatively coupled to powder delivery device 114, gas delivery device 115, energy delivery device 116, stage 120, powder source 142, and/or gas source 143 using respective communication connections. In some examples, the communication connections may include network links, such as Ethernet, ATM, or other network connections. Such connections may be wireless and/or wired connections. In other examples, the communication connections may include other types of device connections, such as USB, IEEE 1394, or the like.

Although FIG. 2 illustrates a single computing device 112 and attributes all control and processing functions to that single computing device 112, in other examples, system 110 may include multiple computing devices 112, e.g., a plurality of computing devices 112. In general, control and processing functions described herein may be divided among one or more computing devices. Computing device 112 may be configured to control operation of powder delivery device 114, gas delivery device 115, energy delivery device 116, and/or stage 120 to position article 10 relative to powder delivery device 114, gas delivery device 115, and/or energy delivery device 116.

Computing device 112 may be configured to control system 110 to deposit layers 16A and 16B as abrasive coating 14 on a substrate 12 to form article 10 based on a set of deposition parameters 113. As shown in FIG. 2A, abrasive coating 14 may include a first layer 16A overlying substrate 12 and a second layer 16B overlying first layer 16A, although many components may be formed of additional layers, such as tens of layers, hundreds of layers, thousands of layers, or the like. Although techniques are described herein with respect to article 10 including substrate 12 and abrasive coating 14 including first layer 16A and second layer 16B, the technique may be extended to articles 10 with more complex geometry and any number of layers.

To form coating 14, computing device 112 may control powder delivery device 114, gas delivery device 115, and energy delivery device 116 to form, on a surface 128 of first layer 16A of material, a second layer 16B of material using an additive manufacturing technique. Computing device 112 may control energy delivery device 116 to deliver energy 134 to a volume at or near surface 128 to form melt pool 132. For example, computing device 112 may control the relative position of energy delivery device 116 and stage 120 to direct energy to the volume. Computing device 112 also may control powder delivery device 114 to deliver powder stream 130 to melt pool 132. For example, computing device 112 may control the relative position of powder delivery device 114 and stage 120 to direct powder stream 130 at or on to melt pool 132. In some examples, computing device 112 may control gas delivery device 115 to deliver gas stream 131 to melt pool 132, such as an inert gas and/or a reactive gas.

Computing device 112 may control powder delivery device 114, gas delivery device 115, and energy delivery device 116 to move energy 134 and powder stream 130 along build surface 128 in a pattern until layer 16B is complete. Computing device 112 then may control a z-axis position of stage 120 and/or powder delivery device 114, gas delivery device 115, and energy delivery device 116 such that melt pool 132 will be formed on surface 136 of second layer 16B, and may control powder delivery device 114, gas delivery device 115, and energy delivery device 116 to move energy 134, gas stream 131, and powder stream 130 along build surface 128 in a pattern until layer 16B is complete. Computing device 112 may control powder delivery device 114, gas delivery device 115, and energy delivery device 116 similarly until all layers are formed to define a completed abrasive coating 14.

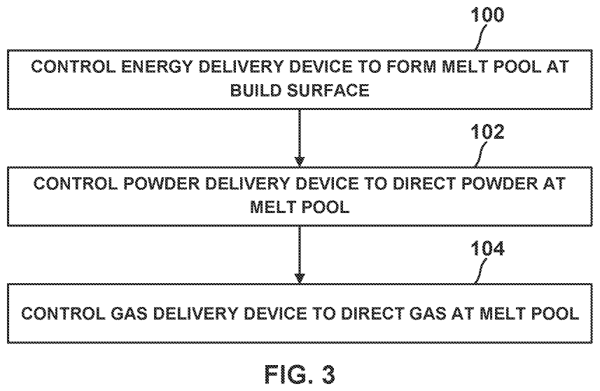

Computing device may control system 110 to form a metal matrix composite via an in situ reaction, wherein the metal matrix composite comprises one or more ceramic phases dispersed in a metal matrix. FIG. 3 is a flowchart illustrating an example method for forming an abrasive coating on a substrate. The example method of FIG. 3 may be implemented by computing device 112 of system 110 of FIG. 2. Abrasive coating 14 may be formed on substrate 12 using any suitable coating deposition technique. Substrate 12 may be masked in some areas to define an exposed surface area onto which abrasive coating 14 is to be formed.

The method of FIG. 3 includes controlling powder delivery device 114 to deliver a powder to build surface 128 of abrasive coating 14 (100). The powder includes a reactive metal powder and another reactant, such as a second reactive powder or a reactive gas. The method of FIG. 3 includes controlling energy delivery device 116 to deliver energy to melt pool 132 of build surface 128 to form a metal matrix composite via an in situ reaction (102), such that the resulting metal matrix composite includes one or more ceramic phases 22 dispersed in metal matrix 20. In some examples, the reactive metal powder includes a reactive metal alloy powder having at least one reactive component, such that the in situ reaction includes an additive reaction. While step 102 is indicated as forming the metal matrix composite, the combination of delivery of the powder, delivery of the energy, and optionally delivery of a gas, may result in the in situ reaction that forms the metal matrix composite.

In some examples, the powder includes a second reactive powder. The second reactive powder may be configured to react with the reactive metal powder to form metal matrix 20 and one or more ceramic phases 22. For example, during deposition, the reactive metal powder may melt and react with the second reactive powder to form the one or more ceramic phases 22. The resulting metal may solidify to form the metal matrix, while ceramic phase 22 may form at grains within metal matrix 20 and/or interfaces between metal matrix 20 and another material, such as ceramic abrasive powder 24.

In some examples, the method of FIG. 3 includes controlling gas delivery device 115 to deliver a reactive gas (104). The reactive gas may be configured to react with the reactive metal powder and form metal matrix 20 and one or more ceramic phases 22. For example, during deposition, the reactive metal powder may melt and react with the second reactive powder to form the one or more ceramic phases 22. The resulting metal may solidify to form the metal matrix, while ceramic phase 22 may form at grains within metal matrix 20 and/or interfaces between metal matrix 20 and another material, such as ceramic abrasive powder 24.

In some examples, the powder includes ceramic abrasive powder 24, such that the resulting metal matrix composite further includes ceramic abrasive powder 24 in metal matrix 20, such as illustrated in abrasive coating 14A of FIG. 1B. In such examples, ceramic phase 22A may form at or migrate to an interface between ceramic abrasive powder 24 and metal matrix 20. In some examples, a composition of ceramic abrasive powder 24 is different from a composition of ceramic phase 22A.

In some examples, the in situ reaction of the reactive metal powder forms one or more ceramic phases 22 as precipitates in metal matrix 20, such as illustrated in abrasive coating 14B of FIG. 1C. A size of the precipitates may be relatively large, such as having a volume-weighted average size greater than about 100 microns, such that the precipitates may function as abrasives for abrading another surface.

Example 1: A method for additive manufacturing includes controlling, by a computing device, a powder delivery device to deliver a powder to a build surface of an abrasive coating, wherein the powder comprises a reactive metal powder; and controlling, by the computing device, an energy delivery device to deliver energy to a melt pool of the build surface to form a metal matrix composite via an in situ reaction, wherein the metal matrix composite comprises one or more ceramic phases dispersed in a metal matrix.

Example 2: The method of example 1, wherein the reactive metal powder comprises a reactive metal alloy powder, and wherein the in situ reaction comprises an additive reaction.

Example 3: The method of any of examples 1 and 2, wherein the reactive metal powder comprises a first material and a second material, and wherein the first material and the second material react via the in situ reaction to form the metal matrix composite.

Example 4: The method of any of examples 1 through 3, wherein the powder further comprises a ceramic abrasive powder, wherein the metal matrix composite further comprises the ceramic abrasive powder in the metal matrix.

Example 5: The method of example 4, wherein the ceramic phase is formed at or migrates to an interface between the ceramic abrasive powder and the metal matrix.

Example 6: The method of any of examples 4 and 5, wherein a composition of the ceramic abrasive powder is different from a composition of the one or more ceramic phases.

Example 7: The method of any of examples 1 through 6, wherein the one or more ceramic phases form a plurality of precipitates in the metal matrix, and wherein a volume-weighted average size of the plurality of precipitates is greater than about 100 microns.

Example 8: The method of any of examples 1 through 7, wherein the metal matrix comprises at least one of titanium, a titanium alloy, nickel, a nickel alloy, cobalt, a cobalt alloy, or a ferrous alloy.

Example 9: The method of any of examples 1 through 8, wherein the metal matrix composite comprises a reinforcement phase comprising carbon, a nitride, alumina, zirconia, or hafnia.

Example 10: The method of any of examples 1 through 9, wherein the metal matrix composite comprises between about 20 volume percent and about 65 volume percent of the one or more ceramic phases.

Example 11: An additive manufacturing system includes an energy delivery device configured to deliver energy to a build surface of a component to form a melt pool in the build surface; a powder delivery device configured to direct a powder stream toward the melt pool; a computing device configured to: control the powder delivery device to deliver a powder to the build surface, wherein the powder comprises a reactive metal powder; and control the energy delivery device to deliver energy to the melt pool to form a metal matrix composite via an in situ reaction, wherein the metal matrix composite comprises one or more ceramic phases dispersed in a metal matrix.

Example 12: The additive manufacturing system of example 11, wherein the reactive metal powder comprises a first material and a second material, and wherein the first material and the second material react via the in situ reaction to form the metal matrix composite.

Example 13: An article includes a substrate; and an abrasive coating overlying the substrate, wherein the abrasive coating comprises a metal matrix composite, and wherein the metal matrix composite comprises one or more ceramic phases dispersed in a metal matrix.

Example 14: The article of example 13, wherein the metal matrix composite further comprises a ceramic abrasive powder in the metal matrix.

Example 15: The article of example 14, wherein the ceramic phase is formed at an interface between the ceramic abrasive powder and the metal matrix.

Example 16: The article of any of examples 14 and 15, wherein a composition of the ceramic abrasive powder is different from a composition of the one or more ceramic phases.

Example 17: The article of any of examples 13 through 16, wherein the one or more ceramic phases form a plurality of precipitates in the metal matrix, and wherein a volume-weighted average size of the plurality of precipitates is greater than about 100 microns.

Example 18: The article of any of examples 13 through 17, wherein the metal matrix comprises at least one of titanium, a titanium alloy, nickel, a nickel alloy, cobalt, a cobalt alloy, or a ferrous alloy.

Example 19: The article of any of examples 13 through 18, wherein the metal matrix composite comprises a reinforcement phase comprising carbon, a nitride, alumina, zirconia, or hafnia.

Example 20: The article of any of examples 13 through 19, wherein the metal matrix composite comprises between about 20 volume percent and about 65 volume percent of the one or more ceramic phases.

Various examples have been described. These and other examples are within the scope of the following claims.

What is claimed is:

1. A method for additive manufacturing, comprising:
controlling, by a computing device, a powder delivery device to deliver a powder to a build surface of an abrasive coating, wherein the powder comprises a reactive metal powder; and
controlling, by the computing device, an energy delivery device to deliver energy to a melt pool of the build surface to form a metal matrix composite via an in situ reaction, wherein the metal matrix composite comprises one or more ceramic phases dispersed in a metal matrix.

2. The method of claim 1,
wherein the reactive metal powder comprises a reactive metal alloy powder, and
wherein the in situ reaction comprises an additive reaction.

3. The method of claim 1,
wherein the reactive metal powder comprises a first material and a second material, and
wherein the first material and the second material react via the in situ reaction to form the metal matrix composite.

4. The method of claim 1,
wherein the powder further comprises a ceramic abrasive powder,
wherein the metal matrix composite further comprises the ceramic abrasive powder in the metal matrix.

5. The method of claim 4, wherein the ceramic phase is formed at or migrates to an interface between the ceramic abrasive powder and the metal matrix.

6. The method of claim 4, wherein a composition of the ceramic abrasive powder is different from a composition of the one or more ceramic phases.

7. The method of claim 1,
wherein the one or more ceramic phases form a plurality of precipitates in the metal matrix, and
wherein a volume-weighted average size of the plurality of precipitates is greater than about 100 microns.

8. The method of claim 1, wherein the metal matrix comprises at least one of titanium, a titanium alloy, nickel, a nickel alloy, cobalt, a cobalt alloy, or a ferrous alloy.

9. The method of claim 1, wherein the metal matrix composite comprises a reinforcement phase comprising carbon, a nitride, alumina, zirconia, or hafnia.

10. The method of claim 1, wherein the metal matrix composite comprises between about 20 volume percent and about 65 volume percent of the one or more ceramic phases.

11. An additive manufacturing system comprising:
an energy delivery device configured to deliver energy to a build surface of a component to form a melt pool in the build surface;
a powder delivery device configured to direct a powder stream toward the melt pool;
a computing device configured to:
control the powder delivery device to deliver a powder to the build surface, wherein the powder comprises a reactive metal powder; and
control the energy delivery device to deliver energy to the melt pool to form a metal matrix composite via an in situ reaction, wherein the metal matrix composite comprises one or more ceramic phases dispersed in a metal matrix.

12. The additive manufacturing system of claim 11,
wherein the reactive metal powder comprises a first material and a second material, and
wherein the first material and the second material react via the in situ reaction to form the metal matrix composite.

13. An article, comprising:
a substrate; and
an abrasive coating overlying the substrate, wherein the abrasive coating comprises a metal matrix composite, and wherein the metal matrix composite comprises one or more ceramic phases dispersed in a metal matrix.

14. The article of claim 13, wherein the metal matrix composite further comprises a ceramic abrasive powder in the metal matrix.

15. The article of claim 14, wherein the ceramic phase is formed at an interface between the ceramic abrasive powder and the metal matrix.

16. The article of claim 14, wherein a composition of the ceramic abrasive powder is different from a composition of the one or more ceramic phases.

17. The article of claim 13,
wherein the one or more ceramic phases form a plurality of precipitates in the metal matrix, and
wherein a volume-weighted average size of the plurality of precipitates is greater than about 100 microns.

18. The article of claim 13, wherein the metal matrix comprises at least one of titanium, a titanium alloy, nickel, a nickel alloy, cobalt, a cobalt alloy, or a ferrous alloy.

19. The article of claim 13, wherein the metal matrix composite comprises a reinforcement phase comprising carbon, a nitride, alumina, zirconia, or hafnia.

20. The article of claim 13, wherein the metal matrix composite comprises between about 20 volume percent and about 65 volume percent of the one or more ceramic phases.
